(19) United States
(12) Patent Application Publication
(10) Pub. No.: US 2020/0128264 A1
(43) Pub. Date: Apr. 23, 2020

(54) IMAGE PROCESSING

(71) Applicant: SZ DJI TECHNOLOGY CO., LTD., Shenzhen (CN)

(72) Inventors: Hao WANG, Shenzhen (CN); Jianhua ZHANG, Shenzhen (CN); Yue DONG, Shenzhen (CN)

(21) Appl. No.: 16/717,237

(22) Filed: Dec. 17, 2019

Related U.S. Application Data
(63) Continuation of application No. PCT/CN2017/104935, filed on Sep. 30, 2017.

(51) Int. Cl. H04N 19/426; G06F 3/06

(52) U.S. Cl. CPC H04N 19/426; G06F 3/0604; G06F 3/0673; G06F 3/0659; G06F 3/0647

(57) ABSTRACT

An image processing method includes reading a portion of pixel data of an array of pixels stored in a first memory. The array of pixels includes a first number of successive rows of pixels and a second number of successive columns of pixels. The portion of the pixel data corresponds to a sub-array of the array of pixels. The image processing method further includes storing the portion of the pixel data into a second memory, and transmitting a sub-portion of the portion of the pixel data from the second memory to an image data processor. The sub-portion of the portion of the pixel data corresponds to at least one pixel matrix in the sub-array.

### CROSS-REFERENCE TO RELATED APPLICATION

This application is a continuation of International Application No. PCT/CN2017/104935, filed Sep. 30, 2017, the entire content of which is incorporated herein by reference.

### TECHNICAL FIELD

The present disclosure generally relates to information processing technique and, more particularly, to methods, systems, and media for image processing.

### BACKGROUND

In existing image/video coding and decoding techniques, an image is generally divided into multiple portions, and each portion of the image is processed separately. For example, in the APPLE PRORES standard, the coding of an image includes sixth steps: code block division, discrete cosine transform (DCT), quantization, scanning, entropy coding, and stream generation. During the code block division, the image is divided into multiple portions along a vertical direction. Each portion has a fixed number of successive rows of pixels, and a same width of the image. After the pixel data of one portion is cached in a buffer, a slice splitter further segments the portion into multiple blocks. The pixel data of each block is then sent to a DCT circuit for processing.

At present, the mainstream consumer electronic products on the market have a huge demand for the high-resolution images and videos, such as 4096×2160 (4K) resolution images and 5280×2160 (5.2K) resolution images. In the existing image and/or video coding and decoding techniques, a size of the buffer for caching each slice of an image is determined by the width of the image and the quantization bit width of the pixel data. An image having a large resolution has a large image width, and/or a large quantization bit width of each pixel. Thus, the size of the buffer is relatively large, which consumes a lot of hardware resources.

### SUMMARY

An aspect of the present disclosure provides an image processing method, comprising: reading a portion of pixel data of an array of pixels stored in a first memory, the array of pixels including a first number of successive rows of pixels and a second number of successive columns of pixels, the portion of the pixel data corresponding to a sub-array of the array of pixels including a third number of successive rows of pixels and a fourth number of successive columns of pixels, the third number being smaller than the first number, and the fourth number being determined based on a quantization bit width of the pixel data and being smaller than the second number; storing the portion of the pixel data into a second memory; and transmitting a sub-portion of the portion of the pixel data from the second memory to an image data processor, the sub-portion of the portion of the pixel data corresponding to at least one pixel matrix in the sub-array, each pixel matrix including the third number of successive rows of pixels.

Another aspect of the present disclosure provides an image data storing method, comprising: reconstituting, based on a quantization bit width of pixel data of an array of pixels, a plurality of storage units in a line-buffer to form a plurality of logic storage array spaces, the array of pixels including a first number of successive rows of pixels and a second number of successive columns of pixels; storing a portion of the pixel data into the plurality of logic storage array spaces, the portion of the pixel data corresponding to a sub-array of the array of pixels including a third number of successive rows of pixels and a fourth number of successive columns of pixels, the third number being smaller than the first number, the fourth number being smaller than the second number, the portion of pixel data being stored in each logic storage array space in an array form that follows relative positions of pixels in the sub-array.

Another aspect of the present disclosure provides a system for image processing, the system comprising: a hardware processor; and a memory storing instructions that, when executed by the hardware processor, cause the hardware processor to: read a portion of pixel data of an array of pixels stored in a first memory, the array of pixels including a first number of successive rows of pixels and a second number of successive columns of pixels, the portion of the pixel data corresponding to a sub-array of the array of pixels including a third number of successive rows of pixels and a fourth number of successive columns of pixels, the third number being smaller than the first number, and the fourth number being determined based on a quantization bit width of the pixel data and being smaller than the second number; store the portion of the pixel data into a second memory, and transmit a sub-portion of the portion of the pixel data from the second memory to an image data processor, the sub-portion of the portion of the pixel data corresponding to at least one pixel matrix in the sub-array, each pixel matrix including the third number of successive rows of pixels.

Another aspect of the present disclosure provides a system for storing image data, the system comprising: a hardware processor; and a memory storing instructions that, when executed by the hardware processor, cause the hardware processor to: reconstitute, based on a quantization bit width of pixel data of an array of pixels, a plurality of storage units in a line-buffer to form a plurality of logic storage array spaces, the array of pixels including a first number of successive rows of pixels and a second number of successive columns of pixels, store a portion of the pixel data into the plurality of logic storage array spaces, the portion of the pixel data corresponding to a sub-array of the array of pixels including a third number of successive rows of pixels and a fourth number of successive columns of pixels, the third number being smaller than the first number, the fourth number being smaller than the second number, the portion of pixel data being stored in each logic storage array space in an array form that follows relative positions of pixels in the sub-array.

Another aspect of the present disclosure provides a non-transitory computer-readable medium containing computer-executable instructions that, when executed by a hardware processor, cause the hardware processor to perform an image processing method, the method comprising: reading a portion of pixel data of an array of pixels stored in a first memory, the array of pixels including a first number of successive rows of pixels and a second number of successive columns of pixels, the portion of the pixel data corresponding to a sub-array of the array of pixels including a third number of successive rows of pixels and a fourth number of successive columns of pixels, the third number being smaller than the first number, and the fourth number being determined based on a quantization bit width of the pixel data and being smaller than the second number; storing the portion of the pixel data into a second memory; and transmitting a sub-portion of the portion of the pixel data from the second memory to an image data processor, the sub-portion of the portion of the pixel data corresponding to at least one pixel matrix in the sub-array, each pixel matrix including the third number of successive rows of pixels.

Another aspect of the present disclosure provides a non-transitory computer-readable medium containing computer-executable instructions that, when executed by a hardware processor, cause the hardware processor to perform an image storing method, the method comprising: reconstituting, based on a quantization bit width of pixel data of an array of pixels, a plurality of storage units in a line-buffer to form a plurality of logic storage array spaces, the array of pixels including a first number of successive rows of pixels and a second number of successive columns of pixels; storing a portion of the pixel data into the plurality of logic storage array spaces, the portion of the pixel data corresponding to a sub-array of the array of pixels including a third number of successive rows of pixels and a fourth number of successive columns of pixels, the third number being smaller than the first number, the fourth number being smaller than the second number, the portion of pixel data being stored in each logic storage array space in an array form that follows relative positions of pixels in the sub-array.

### BRIEF DESCRIPTION OF THE DRAWINGS

Various objects, features, and advantages of the disclosure can be more fully appreciated with reference to the following detailed description of embodiments when considered in connection with the drawings, in which like reference numerals identify like elements unless otherwise specified. It should be noted that the drawings are merely examples for illustrative purposes according to various disclosed embodiments and are not intended to limit the scope of the present disclosure.

FIG. 1 illustrates a flow diagram of an exemplary method for image processing in accordance with some embodiments of the disclosure;

FIG. 2 illustrates a data flow diagram of the method for image processing shown in FIG. 1 in accordance with some embodiments of the disclosure;

FIG. 3 illustrates a schematic diagram of an exemplary segmentation of an image including an array of pixels in accordance with some embodiments of the disclosure;

FIG. 4A illustrates a schematic diagram of an exemplary data storage structure in accordance with some embodiments of the disclosure;

FIG. 4B illustrates a schematic diagram of another exemplary data storage structure in accordance with some other embodiments of the disclosure;

FIG. 5 illustrates a schematic diagram of an exemplary addressing mode for burst accesses to pixel data in accordance with some embodiments of the disclosure;

FIG. 6A illustrates a schematic structural diagram of an exemplary addressing circuit in accordance with some embodiments of the disclosure;

FIG. 6B illustrates a schematic diagram of an exemplary coordinate addressing scheme in accordance with some embodiments of the disclosure;

FIG. 7 illustrates a schematic logic structural diagram of an exemplary pixel data segmentation circuit and a ping-pong buffer in accordance with some embodiments of the disclosure;

FIG. 8 illustrates schematic diagrams of exemplary minimum sizes of a ping-pong buffer for different quantization bit widths in accordance with some embodiments of the disclosure;

FIG. 9 illustrates schematic diagrams of exemplary reconstitution results of a line buffer for different quantization bit widths in accordance with some embodiments of the disclosure;

FIG. 10 illustrates a schematic hardware structural diagram of an exemplary apparatus for image processing in accordance with some embodiments of the disclosure;

FIG. 11 illustrates a schematic hardware structural diagram of an exemplary system for implementing an image processing method in accordance with some embodiments of the disclosure; and

FIG. 12 illustrates a schematic structural diagram of another exemplary system for implementing an image processing method in accordance with some other embodiments of the disclosure.

### DETAILED DESCRIPTION

Exemplary embodiments of the disclosure will be described in more detail below with reference to the drawings. The described embodiments are some but not all of the embodiments of the present disclosure. Based on the disclosed embodiments, persons of ordinary skill in the art may derive other embodiments consistent with the present disclosure, all of which are within the scope of the present disclosure.

In accordance with various embodiments, the present disclosure provides methods, systems, and media for image processing. In the disclosed method, a new segmentation strategy is implemented to process image data, and a reconstitution of a ping-pong buffer is applied. As such, the image block segmentation can be realized with a low cost of storage resource for images of different resolutions under different quantization bit widths, such as 8 bits, 10 bits, and/or 12 bits. Additionally, by locating valid data of effective pixels, the method can support any suitable high resolution images with any suitable image format.

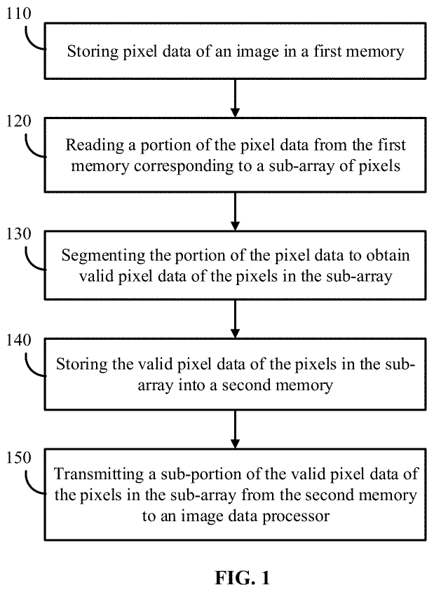

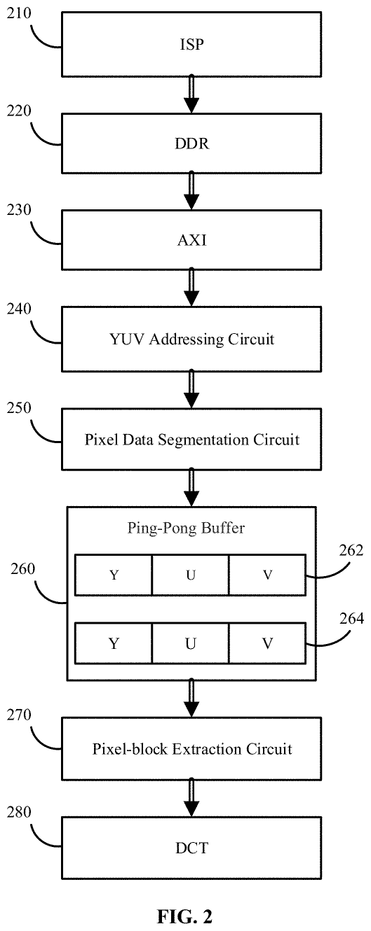

FIG. 1 shows a flow diagram of an exemplary method for image processing in accordance with some embodiments of the disclosure. FIG. 2 shows a data flow diagram of the method for image processing in accordance with some embodiments of the disclosure.

As illustrated in FIG. 1, at 110, pixel data of an image is stored in a first memory. In some embodiments, the image can include an array of pixels, and the pixel data of the image can include information of pixels in the array of pixels. The information, i.e., pixel data, of a pixel can be, for example, color information and/or brightness information of the pixel. The array of pixels can include a first number of successive rows of pixels and a second number of successive columns of pixels. In some embodiments, the image can be any suitable digital image with any suitable resolution.

The resolution of the image can be defined as a total number of pixels in the array. For example, the image can be a high resolution digital image, such as a 4K resolution image, a 5.2K resolution image, etc. In a 4K resolution image, the first number can be 4096 and the second number can be 2160, so that the image can have a width of 4096 pixels and a depth of 2160 pixels. In a 5.2K resolution image, the first number can be 5280 and the second number can be 2160, so that the image can have a width of 5280 pixels and a depth of 2160 pixels. In some embodiments, the image may have a height and/or a width including a number of pixels that is a multiple of eight or sixteen. In this disclosure, the width and the depth of an image in terms of number of pixels are also referred to as an “image width” and an “image depth” of the image, respectively.

In some embodiments, the image can be either a static picture, or a frame of a video including multiple successive frames. The pixel data of the image can be obtained from any suitable source. For example, as shown in FIG. 2 the pixel data of the image can be transmitted from an image signal processor (ISP) 210 of a digital camera, a mobile phone, an unmanned aerial vehicle, or any other suitable device that includes an image capturing device. Further, the first memory for storing the pixel data of the image can be any suitable memory device for storing data. For example, as shown in FIG. 2, the pixel data of the image can be stored in a double data rate synchronous dynamic random-access memory (DDR SDRAM, hereinafter “DDR” for short) 220 as the first memory.

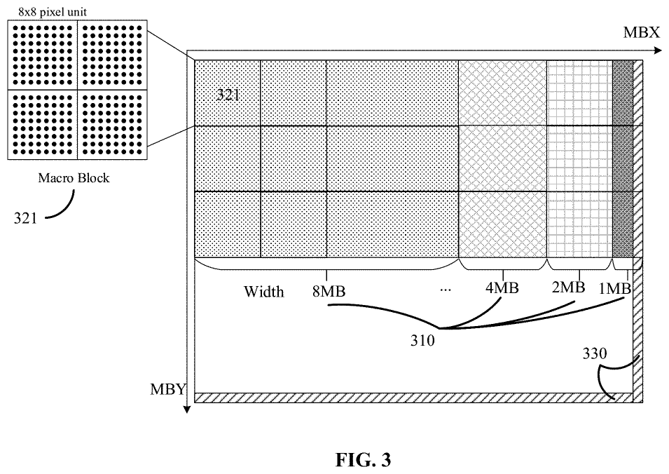

In some embodiments, the image including an array of pixels can be divided into multiple portions. FIG. 3 shows a schematic diagram of an exemplary segmentation of an image including an array of pixels in accordance with some embodiments of the disclosure.

In some implementations, using the APPLE PRORES standard as an example, the coding of an image can include code block division, discrete cosine transform (DCT), quantization, scanning, entropy coding, and stream generation. During the code block division, the image is divided into multiple portions along a vertical direction. Each portion has a fixed number of successive rows of pixels, and a same width of the image. After the pixel data of one portion is cached in a buffer, a slice splitter further segments the portion into multiple blocks. The pixel data of each block is then sent to a DCT circuit for processing.

Accordingly, the image including the array of pixels can be segmented into multiple slices 310 as illustrated. Each slice 310 can include one or more macro blocks (MBs) 321 that are successively arranged in a horizontal direction, labeled as an MBX direction in FIG. 3. The slices 310 of different sizes may include different number of macro blocks 321. In some embodiments, a slice 310 can include eight macro blocks 321, four macro blocks 321, two macro blocks 321, or one macro block 321.

In some embodiments, one slice 310 can be set to generally include eight macro blocks 321. However, in the horizontal direction, i.e., the MBX direction shown in FIG. 3, different images with different resolutions may have different numbers of macro blocks 321. That is, a number of macro blocks 321 in the horizontal direction may not necessarily equal to an integer multiple of eight. Therefore, in some embodiments, one or more last slices 310 at the end of the image in the horizontal direction may not necessarily include eight macro blocks 321. The portion of the image including the one or more last slices 310 that each includes less than eight macro blocks is referred to as a “tail portion” of the image in the horizontal direction.

For example, if the tail portion of an image in the horizontal direction has seven macro blocks 321, the tail portion can be divided into three slices 310, e.g., a first slice 310 including four macro blocks 321, a second slice 310 including two macro blocks 321, and a third slice 310 including one macro block 321. If the tail portion of an image in the horizontal direction has six macro blocks 321, the tail portion can be divided into two slices 310, e.g., a first slice 310 including four macro blocks 321 and a second slice 310 including two macro blocks 321. If the tail portion of an image in the horizontal direction has five macro blocks 321, the tail portion can be divided into two slices 310, e.g., a first slice 310 including four macro blocks 321 and a second slice 310 including one macro block 321. If the tail portion of an image in the horizontal direction has four macro blocks 321, the tail portion can be treated as one slice 310 that includes four macro blocks 321. If the tail portion of an image in the horizontal direction has three macro blocks 321, the tail portion can be divided into two slices 310, e.g., a first slice 310 including two macro blocks 321 and a second slice 310 including one macro block 321. If the tail portion of an image in the horizontal direction has two macro blocks 321, the tail portion can be treated as one slice 310 that includes two macro blocks 321. If the tail portion of an image in the horizontal direction has one macro block 321, the tail portion can be treated as one slice 310 that includes one macro block 321.

As shown in FIG. 3, a macro block can include four 8*8 pixel units, also referred to as “pixel blocks,” that are arranged in four quarters of the macro block, separately. Each 8*8 pixel unit can include 64 pixels that are arranged in an array having eight rows and eight columns. That is, a height of a slice 310 in the vertical direction, labeled as an MBY direction in FIG. 3, can be 16 rows of pixels. A width of a slice 310 in the horizontal direction, i.e., the MBX direction as shown in FIG. 3, can be, e.g., 16*8, or 16*4, or 16*2, or 16 columns of pixels. A height of a slice 310 in the vertical direction can include any suitable numbers of rows of pixels.

In some embodiments, a height and/or a width of the image may not include a number of pixels that is a multiple of eight or sixteen. In such embodiments, a picture filling portion 330 may be added to the right-most end of the image in the horizontal direction and/or to the bottom-most end of the image in the vertical direction. As such, the total numbers of pixels in the array in both the horizontal direction and the vertical direction can be multiples of sixteen. Therefore, both the width and the height of the image can include integer-number(s) of macro blocks 321.

Referring again to FIG. 1, the image can be stored in the first memory in any suitable image format, such as joint photographic experts group (JPEG) format, graphics interchange format (GIF), portable network graphics (PNG) format, bitmap (BMP) format, WebP format, etc. Further, the image can be stored by using any suitable color model, such as RGB model, CMYK model, YUV model, etc. It is noted that, different pixel data segmentation circuit may be applied to different image format. In the following, a pixel data segmentation circuit for codec standard is described in detail as an example for demonstrating the disclosed methods.

In some embodiments, by using the YUV model, the pixel data of each pixel can include three layers of information: Y-component, U-component, and V-component. The Y-component can indicate the luminance (or Luma) information of the pixel, i.e., a grayscale value of the pixel. The U-component and the V-component can indicate the chrominance (or Chroma) information of the pixel, i.e., a color of the pixel. That is, the U-component and the V-component can describe the color and saturation of the pixel.

A number of bits used for storing a component of each pixel can be referred to as a quantization bit width. For example, for the RGB model using red, green, and blue primary colors to represent one pixel, every primary color uses one byte (8 bits), so that when the quantization bit width is 8 bits, a pixel requires 8*3=24 bits in total. A YUV model can be, e.g., a YUV444 model or a YUV 422 model depending on a sampling frequency, For example, for the YUV444 model, a Y-component, a U-component, and a V-component are sampled for each pixel. As such, when the quantization bit width is 8 bits, each of the Y-component, the U-component, and the V-component uses 8 bits, and a pixel requires 8*3=24 bits in total. On the other hand, for the YUV422 model, a Y-component is sampled for every pixel, while a U-component and a V-component are sampled for every two pixels. As such, when the quantization bit width is 8 bits, one average for one pixel, the Y-component uses 8 bits, the U-component and the V-component each use 4 bits, and a pixel, on average, requires 8+4+4=16 bits in total.

When using YUV444 model, the pixel data of each macro block 321 can include Y-component data of four 8*8 pixel units, U-component data of four 8*8 pixel units, and V-component of four 8*8 pixel units. When using YUV422 model, the pixel data of each macro block 321 can include Y-component data of four 8*8 pixel units, U-component data of two 8*8 pixel units, and V-component data of two 8*8 pixel units.

In some embodiments, the pixel data of the image with YUV model can be stored in the first memory using any suitable storing format, such as a packed format, a planar format, a semi-planer format, etc. When using the packed format, the Y-component data, the U-component data, and the V-component data can be stored in a same array of a storage unit. When using the planar format, three arrays of a storage unit can be used to store the Y-component data, the U-component data, and the V-component data, respectively. When using the semi-planar format, one array can be used to store the Y-component data, and another array can be used to store the U-component data and the V-component data.

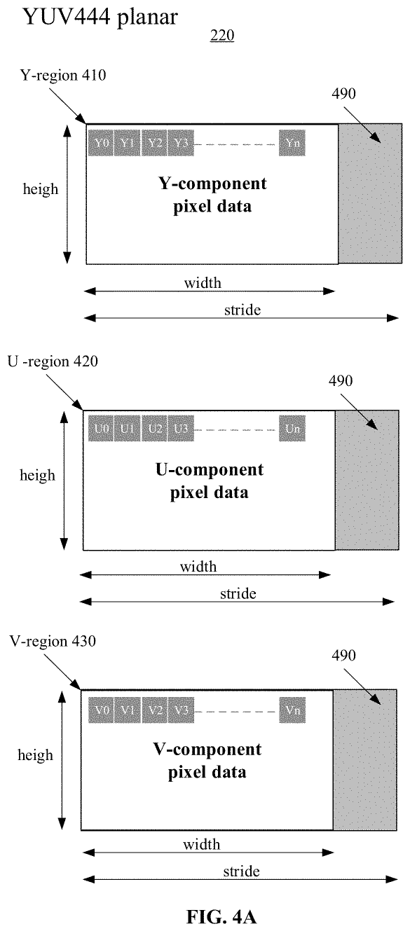

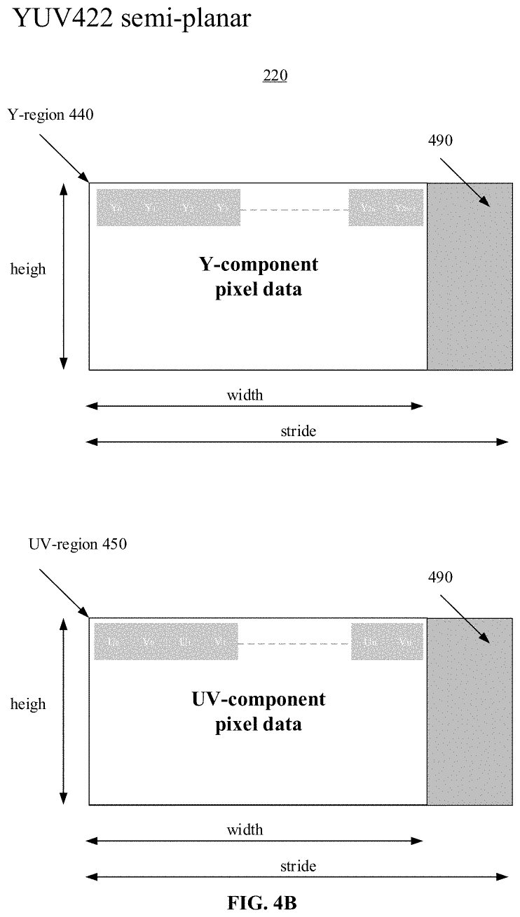

FIGS. 4A and 4B show schematic diagrams of exemplary data storage structures including the YUV444 planar format and the YUV422 semi-planar format, respectively, in accordance with some embodiments of the disclosure.

As illustrated in FIG. 4A, when the pixel data of the image is stored in the DDR 220 using the YUV444 planar format, the DDR 220 can include a Y-region 410, a U-region 420, and a V-region 430 for storing the Y-component data, the U-component data, and the V-component data, respectively. In each of the Y-region 410, the U-region 420, and the V-region 430, the Y-component data, the U-component data, and the V-component data of the array of pixels of the image can be stored based on the following rules. In the horizontal direction (width direction), the pixels in each row can be recorded from left to right, and in the vertical direction (height direction), different rows of pixels can be recorded from up to bottom.

As illustrated in FIG. 4B, when the pixel data of the image is stored in the DDR 220 using the YUV422 semi-planar format, the DDR 220 can include a Y-region 440 and a UV-region 450. In the Y-region 440, the Y-component data of the array of pixels of the image can be stored based on the same rules of the Y-region 410 discussed above in connection with FIG. 4A. In the UV-region 450, the U-component data and the V-component data of every two adjacent pixels in one row can be stored in the storage space.

The number of pixels corresponding to the pixel data stored in every 128 bits storage space in the DDR 220 can depend on the quantization bit width. If the quantization bit width is 8 bits, every 128-bit storage space in the DDR 220 can store the Y-component pixel data of 16 pixels. If the quantization bit width is 10 bits, every 32-bit storage space in the DDR 220 can store the Y-component pixel data of 3 pixels, and the data in the last two bits of each 32-bit storage space is invalid. That is, every 128-bit storage space in the DDR 220 can store the Y-component pixel data of 12 pixels when the quantization bit width is 10 bits. If the quantization bit width is 12 bits, every 128-bit storage space in the DDR 220 can store the Y-component pixel data of 10 pixels, and the data in the last eight bits of each 128-bit storage space is invalid.

In some embodiments, in order to facilitate bus addressing, the Y-component data, the U-component data, or the V-component pixel data of one row of pixels occupies a storage space in the DDR having a number of bytes that is an integer multiple of 128 bytes. This number of bytes is also referred to as a “stride,” and the integer can be referred to the length of the stride. Thus, in the cases that the a row of pixels of the image occupies a smaller storage space than a stride, a compensation region 490 containing invalid data can be provided in each of the Y-region 410, the U-region 420, and the V-region 430 in the YUV444 format, or each of the Y-region 440 and the UV-region 450 in the YUV422 format. For example, as shown in FIG. 4A, the compensation region 490 is provided at the right-most part of each of the Y-region 410, the U-region 420, and the V-region 430. Further, as shown in FIG. 4B, or the compensation region 490 is provided at the right-most part of each of the Y-region 440 and the UV-region 450.

Referring again to FIG. 1, at 120, a portion of the pixel data is read from the first memory. In some embodiments, the portion of the pixel data can correspond to a sub-array of the array of pixels. The sub-array of pixels can include a third number of successive rows of pixels and a fourth number of successive columns of pixels. The third number can be smaller than the first number, and the fourth number can be smaller than the second number.

The portion of the pixel data can be read from the first memory by using any suitable technique or process. In some embodiments, as shown in FIG. 2, the first memory can be the DDR 220, and the portion of the pixel data can be read from the DDR 220 through an addressing mode issued by an advanced extensible interface (AXI) bus 230. When the pixel data is stored in the DDR 220 according to the YUV model, a YUV addressing circuit 240 can be used to locate the addresses of the Y-component, the U-component, and the V-component of the portion of the pixel data in the DDR 220, such that the different components of the pixel data can be read from the corresponding addresses of the DDR 220.

In some existing technologies, the pixel data stored in buffer is directly read from ISP. Thus, after the pixel data of an entire row is read from the ISP, the pixel data of a following row can be read. In contrast, consistent with embodiments of the disclosed method, the pixel data can be read from the ISP and stored in a DDR. As such, after the pixel data of a portion of a first row of pixels is read from the DDR, the pixel data of a portion of a second row of pixels can be read from the DDR without waiting for the pixel data of the entire first row to be read.

In some embodiments, the third number can be 16. That is, a depth of the sub-array of pixels is equal to a depth of the macro block 321. It is noted that, the fourth number can depend on the storage space of a second memory (e.g., a buffer), the quantization bit width of the pixel data, and the bit width of an advanced extensible interface (AXI) bus 230. The valid pixel data of the portion of the pixel data read from the first memory at 120 can be subsequently stored into the second memory at 130, thus the size of the portion of the pixel data read from the first memory at 120 can be designed to fulfill the size of the second memory. Based on the storage space of the second memory, the quantization bit width of the pixel data, and the bit width of the AXI bus 230, the fourth number can be calculated.

For example, when the bit width of the AXI bus 230 is 128 bits, the fourth number can be determined based on the quantization bit width. When the quantization bit width is 8 bits, the sub-array of pixels can include 32 macro blocks 321 in the width direction, i.e., the horizontal direction. That is, the fourth number can be 32*16=512. When the quantization bit width is 10 bits, the sub-array of pixels can include 24 macro blocks 321 in the width direction. That is, the fourth number can be 24*16=384. When the quantization bit width is 12 bits, the sub-array of pixels can include 20 macro blocks 321 in the width direction. That is, the fourth number can be 20*16=320. The numbers of the macro blocks 321 included in the sub-array of pixels for different quantization bit widths are related to a number of batches of burst access operations described below.

In some embodiments, a batch of burst access operations can be performed successively to read the pixel data of the sub-array of pixels. For example, as shown in FIG. 2, the YUV addressing circuit 240 can perform a batch of burst access operations successively to access the AXI bus 230 to read the Y-component, the U-component, and the V-component of pixel data of the sub-array of pixels in the sub-array from the DDR 220.

The addressing circuit 240 can employ the burst access type supported by the AXI bus standard, and can also support both the “outstanding” characteristic and the “out of order” characteristic. That is, multiple batches of burst access requests can be issued following an order, and the return data corresponding to the multiple batches of burst access requests can be intertwined between the multiple batches, but the return data corresponding to a single batch follows an internal order of the access requests in the single batch.

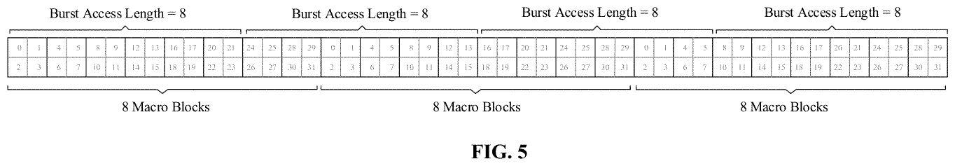

FIG. 5 shows a schematic diagram of an exemplary addressing mode for burst accesses to pixel data in accordance with some embodiments of the disclosure. In some embodiments, the number of batches of burst access requests, the number of burst access requests, and the order of the burst access operations can be determined based on the access efficiency of the first memory, as well as the storage unit size of the first memory.

As illustrated, a length of one batch of burst access operations can be set as 8. That is, eight successive burst access operations can be performed successively. When the bit width of the AXI bus 230 is 128 bits, each batch of burst access operations can read 128 bytes of pixel data. The order of the burst access operations can be set to follow the address increment.

In some embodiments, four batches of burst access operations can be initiated consecutively in the horizontal direction for reading one component of pixel data of a row of pixels. For example, Y-component of pixel data of a first row of pixels in the sub-array can be read first. When the quantization bit width is 8 bits, the Y-component of pixel data of 512 pixels can be read. That is, a width of the sub-array is 32 macro blocks. When the quantization bit width is 10 bits, the Y-component of pixel data of 384 pixels can be read. That is, a width of the sub-array is 24 macro blocks, as shown in FIG. 5. When the quantization bit width is 12 bits, the Y-component of pixel data of 320 pixels can be read. That is, a width of the sub-array is 20 macro blocks.

A number of the batches of access operations initiated consecutively in the horizontal direction for reading one component of pixel data of a row of pixels can be determined based on a balance consideration between a response efficiency of the first memory (e.g., the DDR) and a storage space efficiency of the second memory (e.g., a buffer).

In one aspect, batches of access operations initiated consecutively on the continuous addresses of the DDR can have a higher response efficiency. If the addresses are not continuous but discrete, the response efficiency may be reduced. In another aspect, if the number of batches of access operations initiated consecutively is large, the storage space of the second memory for storing the pixel data read by the batches of access operations in the subsequent processes may also become large. For example, the storage space of the second memory for storing the pixel data read by the batches of access operations in the subsequent processes can be proportional to the number of batches of access operations initiated consecutively.

In some embodiments, one slice can include, e.g., eight macro blocks of pixels. One batch of access operations can read back pixel data of 8 macro blocks of pixels when the quantization bit width is 8 bits, or can read back pixel data of 6 macro blocks of pixels when the quantization bit width is 10 bits, or can read back pixel data of 5 macro blocks of pixels when the quantization bit width is 12 bits. Thus, if one batch of access operations is performed at once, the requirement for storage space of the second memory can be reduced, but the pixel data read back when the quantization bit width is 10 bits or 12 bits may not correspond to an integer number of slices. Similarly, if two batches of access operations or three batches of access operations are performed at once, the pixel data read back when the quantization bit width is 10 bits or 12 bits may also not correspond to an integer number of slices. Therefore, the response efficiency may be reduced.

On the other hand, four batches of access operations can read back pixel data of 32 macro blocks of pixels when the quantization bit width is 8 bits, or can read back pixel data of 24 macro blocks of pixels when the quantization bit width is 10 bits, or can read back pixel data of 20 macro blocks of pixels when the quantization bit width is 12 bits. That is, the pixel data read back can correspond to 4 slices, 3 slices, and 2.5 slices when the quantization bit width is 8 bits, 10 bits, and 12 bits respectively. Thus, two or three turns of four batches of access operations can read back pixel data corresponding to an integer number of slices.

Accordingly, in some embodiments, considering the balance between the response efficiency of the first memory (e.g., the DDR) and the storage space efficiency of the second memory (e.g., the buffer), the number of batches of access operations initiated consecutively in the horizontal direction for reading one component of pixel data of a row of pixels can be determined as four.

After the Y-component of pixel data of the first row of pixels in the sub-array is read, the YUV addressing circuit 240 can initiate another four batches of burst access operations through the AXI bus 230 to read the Y-component of pixel data of the second row of pixels in the sub-array, starting from the first pixel of the second row of pixels in the sub-array. After finishing reading the Y-component of pixel data of the 16 rows of pixels in the sub-array, the U-component and the V-component of pixel data of pixels in the sub-array can be read respectively following a same process.

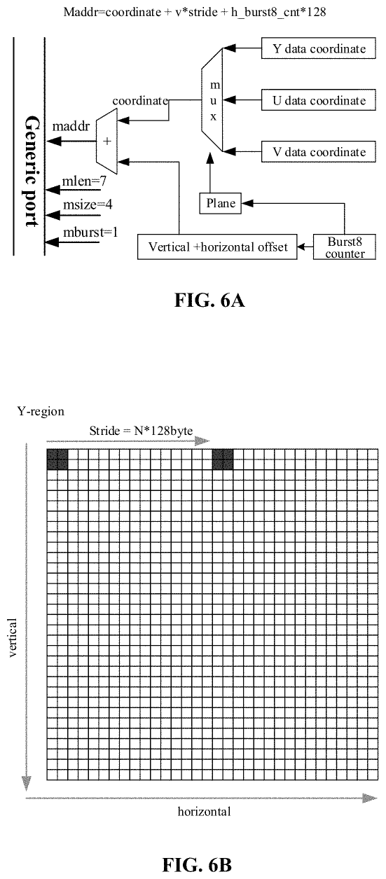

FIGS. 6A and 6B show a schematic logic structural diagram of an exemplary YUV addressing circuit and a schematic diagram of an exemplary coordinate addressing scheme, respectively, in accordance with some embodiments of the disclosure.

Assuming the pixel data is stored in the DDR 220 according to the YUV model, the address of each burst access operation initiated by the YUV addressing circuit 240 can include at least three portions, as shown in FIG. 6A. In FIG. 6A, “maddr” denotes the address of a burst access operation. The first portion, i.e., “coordinate” in FIG. 6A, can include the address of a coordinate point for the Y-component of pixel data in the Y-region 410, the address of a coordinate point for the U-component of pixel data in the U-region 420, or the address of a coordinate point for the V-component of pixel data in the V-region 430. The second portion can include a product of the length of one stride (e.g., 8) and the number of rows of pixels in the sub-array, i.e., “v” in FIG. 6A, (e.g., 16). The third portion can include a product of 128 bytes and a number of batches of burst access operations, i.e., “Burst8_counter” in FIG. 6A, (e.g., 4) that corresponds to the addresses of coordinate points.

In FIG. 6A, “Generic port” is a bus port which can be transferred to AXI protocol bus port to access DDR space, and “mlen,” “msize,” and “mburst” are signals of the Generate port. The “mlen” denotes a length of one batch of burst access operations. When the “mlen” is configured to be 7 as shown in FIG. 6A, the Generac port can access the DDR at a length of one batch of burst access operations of 8. The “msize” denotes the number of bytes of every burst access operation. The “mburst” denotes a type of burst access operation. When “mburst” equaling 1 as shown in FIG. 6A means that the address will increase automatically.

Further, in FIG. 6A, “mux” denotes an abbreviation of multiplexer. “Vertical+horizontal offset” denotes a summation of the address offset at the vertical direction and the address offset at the horizontal direction. “Plane” indicates processing data belong to Y or U or V plane. “Burst8_counter” denotes a counter used to count the times of DDI accessing at burst 8 length mode, that is, the number of batches of burst access operations.

For example, FIG. 6B schematically shows the Y-region 410 as an example. In FIG. 6B, each square represents an 8*8 pixel unit, and four squares forming a larger square represent a macro block. The first coordinate point of the Y-component of pixel data is the first pixel of the gray block in the upper left corner of FIG. 6B. After 64 batches of burst access operations (including four batches of burst access operations in the horizontal direction for each of 16 successive rows in the vertical direction) are performed in the Y-region, the coordinate point of the Y-component of pixel data can be updated to the first pixel of the gray block in the upper right part of FIG. 6B.

In some embodiments, if the pixel data of the image is in the YUV444 planar format, after the Y-component of pixel data of a single slice in the Y-region 410 is read, the address of the coordinate point can be switched to the U-region 420. After the U-component of pixel data of the single slice in the U-region 420, the address of the coordinate point can be switched to the V-region 430. If the pixel data of the image is in the YUV422 semi-planar format, after the Y-component of pixel data of the single slice in the Y-region 440 is read, the address of the coordinate point can be switched to the UV-region 450.

In some embodiments, after reading the Y-component, the U-component, and the V-component of the pixel data of the first slice, the pixel data of a second slice next to the first slice in the same row of macro blocks in the horizontal direction can be read. After reading the pixel data of the first row of macro blocks in the horizontal direction, the coordinate point of pixel data can be updated to the first pixel of the first row of pixels in the second row of macro blocks, i.e., the seventeenth row of pixels of the entire image, to read the pixel data of the second row of macro blocks in the horizontal direction. The above process can be repeated until the pixel data of the entire image is read.

Referring again to FIGS. 1 and 2, at 130, the portion of the pixel data read from the first memory can be segmented to obtain valid pixel data of the pixels in the sub-array. For example, a pixel data segmentation circuit 250 shown in FIG. 2 can segment the portion of the pixel data read from the DDR 220 to extract valid pixel data. Further, the pixel data segmentation circuit 250 can generate storage addresses of the valid pixel data of the pixels in the sub-array. At 140, the valid pixel data of the pixels in the sub-array can be stored into a second memory based on the storage addresses. In some embodiments, the second memory can be a ping-pong buffer 260 shown in FIG. 2.

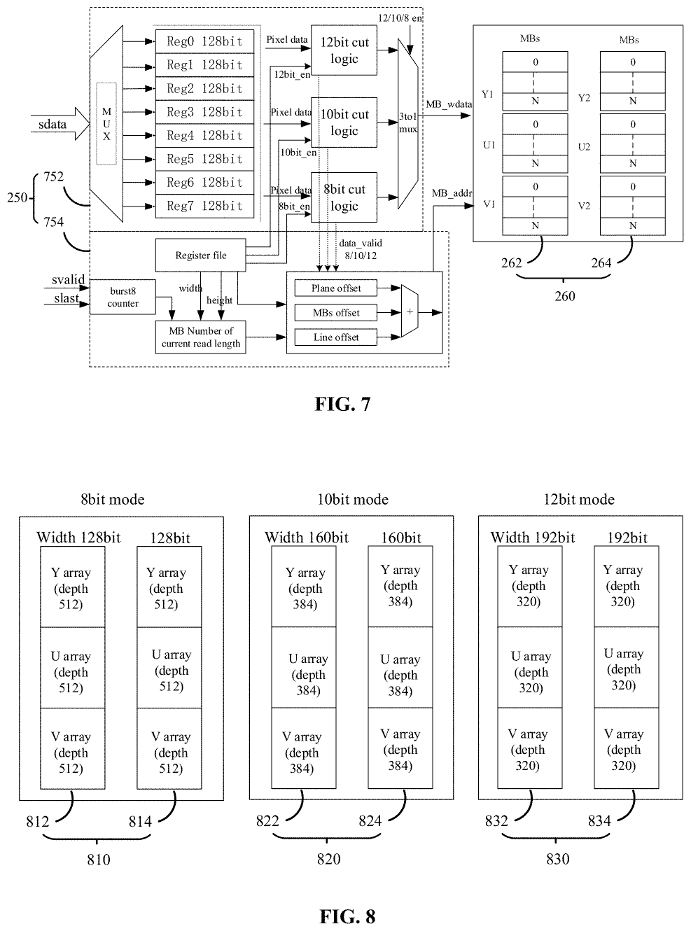

FIG. 7 shows a schematic logic structural diagram of an exemplary pixel data segmentation circuit and a ping-pong buffer in accordance with some embodiments of the disclosure. As illustrated, the pixel data segmentation circuit 250 can include a data segmenting unit 752 and a storage addresses generating unit 754.

In FIG. 7, “sdata,” “svalid,” and “slat” refer to signals of the Generic port. The value of “sdata” is pixel data read back by the Generic port from DDR. The “svalid” is used to indicate whether the “sdata” is valid. The “slat” is used to indicate whether the current “sdata” is the pixel data of the last pixel of the burst access operation.

The data segmenting unit 752 can be used to extract valid pixel data from every 128 bits of data read from the DDR 220. For different quantization bit widths of the pixel data, the locations of the valid pixel data in the 128 bits of data are different. For example, when the quantization bit width is 10 bits, the 30th, 31st, 62nd, 63rd, 94th, 95th, 126th, and 127th bits in the 128 bits of data can be invalid data. As another example, when the quantization bit width is 12 bits, the 120th to 127th bits in the 128 bits of data can be invalid data.

The data segmenting unit 752 can be further used to extract valid pixel data from the 128 bytes of data from the tail portion of the image for every row of pixels. A last burst access operation is performed to read the pixel data at the tail portion of the image for each row of pixels. The 128 bytes of data read by the last burst access operation may include valid pixel data for different number of pixels in the tail portion of the image for every row of pixels that depends on the resolution of the image. Therefore, data segmenting unit 752 can calculate the number of pixels in the tail portion of the image for every row of pixels according to the resolution. For example, when the quantization bit width is 10 bits, the number of pixels in the tail portion of the image for each row of pixels may be 8, 16, 24, 32, 40, 48, 56, 64, 72, 80, 88, or 96, which are 12 possibilities in total.

In some embodiments, the data segmenting unit 752 can include multiple data cut logic circuits for different quantization bit widths. For example, as shown in FIG. 7, the data segmenting unit 752 includes an 8 bits cut logic circuit, a 10 bits cut logic circuit, a 12 bits cut logic circuit which are independent from each other. The multiple data cut logic circuits can be enabled by register configuration units (labelled as “Resister file” in FIG. 7), respectively, based on corresponding software configuration.

In some embodiments, in each clock cycle, the data segmenting unit 752 can send out Y-component, U-component, or V-component of pixel data of 16 pixels, which corresponds to the pixel data of one row of pixels in a macro block 321. The storage addresses generating unit 754 can be used to calculate the storage addresses of the pixel data for every row of pixels in one macro block cached in the second memory.

The second memory can include one or more line buffers. Each line buffer can include multiple logic storage array spaces. In some embodiments, as illustrated in FIGS. 2 and 7, the second memory includes a ping-pong buffer 260 including a first line buffer 262 and a second line buffer 264. Each of the first line buffer 262 and the second line buffer 264 can include a first logic storage array space for caching Y-component of pixel data, a second logic storage array space for caching U-component of pixel data, and a third logic storage array space for caching V-component of pixel data.

In some embodiments, each of the plurality of macro blocks may be associated with an order number, which indicates a relative location of the image in the horizontal direction. For example, the plurality of macro blocks in each row can be associated with order numbers that increase from left to right. That is, a row of 24 macro blocks can have order numbers from 0 to 23 for the 24 macro blocks, respectively. In each logic storage array space, the pixel data can be cached in a sequence that follows an increment of the order numbers of the macro blocks. For each macro block, the pixel data of the pixels in the first row of the macro block can be cached first, and the pixel data of the pixels in the second row of the macro block can be cached next, then the pixel data of the pixels in the third row of the macro block, and so on.

The addresses of pixel data for each macro block can include three parts that can be generated by a counter, e.g., a Burst8_counter as shown in FIG. 7. The first part can include head addresses for the Y-component of pixel data, the U-component of pixel data, and/or the U-component of pixel data that indicate the starting location for storing the Y-component of pixel data, the U-component of pixel data, and/or the U-component of pixel data, respectively. The second part can include the address determined by the order number of the macro block, since the pixel data read by each batch of burst access operations can belong to different macro blocks. The third part can include the address of the row including the macro block.

Taking the quantization bit width of 10 bits as an example, each 128 bytes of pixel data read by a burst access operation can be stored in order in multiple data registers, such as the eight data registers including Reg0 to Reg7 shown in FIG. 7. A size of each of the eight data registers including Reg0 to Reg7 can be 128 bits. The 10 bits cut logic circuit can read the pixel data stored in the eight data registers, and send six batches of valid pixel data one by one in turn in every six clock cycles. Each batch of valid pixel data includes pixel data of 16 pixels. Four consecutive rounds of six batches of valid pixel data can correspond to a row of pixels of 24 macro blocks that have order numbers from 0 to 23 respectively.

As such, the Y-component of valid pixel data for a first row of pixels of 24 macro blocks can be cached in the first logic storage array space at the addresses of 0, 16, 32, 48, 64, 80, etc., which are incremented by 8 respectively. The next 24 batches of valid pixel data of 16 pixels corresponding to the second row of pixels of the 24 macro blocks can be cached in the first logic storage array space at the addresses of 1, 17, 33, 49, 65, 81, etc., which are also incremented by 8 respectively. The Y-component of valid pixel data for the remaining rows of pixels of the 24 macro can be cached in the first logic storage array space following the same scheme as described above.

After the Y-component of valid pixel data for all of the 24 macro blocks has been cached in the first logic storage array space of one line buffer, the U-component of valid pixel data for the 24 macro blocks can be cached in the second logic storage array space of the one line buffer. A head address of the U-component of valid pixel data for the 24 macro blocks can be 320. Then the V-component of valid pixel data for the 24 macro blocks can be cached in the third logic storage array space of the one line buffer. A head address of the V-component of valid pixel data for the 24 macro blocks can be 640.

Referring again to FIG. 1, at 150, a sub-portion of the valid pixel data of the pixels in the sub-array can be transmitted from the second memory to an image data processor. The sub-portion of the valid pixel data of the pixels in the sub-array can correspond to at least one pixel matrix in the sub-array. In some embodiments, each pixel matrix can be a macro block 321. That is, each pixel matrix can include the third number (e.g., 16) of successive rows of pixels, and the third number (e.g., 16) of successive columns of pixels.

In some embodiments, the second memory can include a ping-pong buffer 260 as shown in FIGS. 2 and 7, and the image data processor can include a discrete cosine transform (DCT) circuit 280. If one of the first line buffer 262 or the second line buffer 264 is full, the valid pixel data of each macro block 321 can be extracted by a pixel-block extraction circuit 270 from the full line buffer.

As illustrated in FIG. 3, each macro block 321 can include four 8*8 pixel units, and the 8*8 pixel units can be numbered as shown in FIG. 5. The number in each pixel unit in FIG. 5 for representing the pixel unit is also referred to as a “unit number.” The valid pixel data of each macro block 321 can be sent out to the DCT circuit 280 following an order of the pixel numbers. For example, for the four pixel units numbered 0, 1, 2, and 3 in the first macro block shown in FIG. 5, the pixel unit with a unit number 0 can be sent out first, then the pixel units with unit numbers 1, 2, and 3 in that order. In each 8*8 pixel unit, the valid pixel data of each row of 8 pixels can be sent out to the DCT circuit 280 from the first row to the eighth row.

In some embodiments, the first line buffer 262 and the second line buffer 264 of the ping-pong buffer 260 can be in different status of reading and writing at a same time point. For example, during a first period that the valid pixel data of a first sub-portion of the sub-array of pixels is transmitting from the first line buffer 262 to the DCT circuit 280, the valid pixel data of a second sub-portion of the sub-array of pixels can be cached into the second line buffer 264. During a second period that the valid pixel data of the second sub-portion of the sub-array of pixels is transmitting from the second line buffer 264 to the DCT circuit 280, the valid pixel data of a third sub-portion of the sub-array of pixels can be cached into the first line buffer 262.

FIG. 8 shows schematic diagrams of exemplary minimum sizes of ping-pong buffer for different quantization bit widths in accordance with some embodiments of the disclosure. Specifically, FIG. 8 schematically shows three exemplary ping-pong buffers 810, 820, and 830 corresponding to the quantization bit widths of 8 bits, 10 bits, and 12 bits, respectively. Further, the ping-pong buffer 810 includes two line buffers 812 and 814, the ping-pong buffer 820 includes two line buffers 822 and 824, and the ping-pong buffer 830 includes two line buffers 832 and 834. As illustrated in FIG. 8, for different quantization bit widths, a minimum depth requirement and a minimum width requirement for each line buffer of the ping-pong buffer can be different.

When the quantization bit width is 8 bits, the four batches of burst access operations in the horizontal direction can read pixel data of one row of pixels of 32 macro blocks. As such, the minimum depth requirement of each of the line buffers 812 and 814 in the ping-pong buffer 810 is 3*32*16=1536, and the minimum width requirement of each of the line buffers 812 and 814 in the ping-pong buffer 810 is 32*4=128 bits.

When the quantization bit width is 10 bits, the four batches of burst access operations in the horizontal direction can read pixel data of one row of pixels of 24 macro blocks. As such, the minimum depth requirement of each of the line buffers 822 and 824 in the ping-pong buffer 820 is 3*24*16=1152, and the minimum width requirement of each of the line buffers 822 and 824 in the ping-pong buffer 820 is 32*5=160 bits.

When the quantization bit width is 12 bits, the four batches of burst access operations in the horizontal direction can read pixel data of one row of pixels of 20 macro blocks. As such, the minimum depth requirement of each of the line buffer 832 and 834 in the ping-pong buffer 830 is 3*20*16=960, and the minimum width requirement of each of the line buffers 832 and 834 in the ping-pong buffer 830 is 32*6=192 bits.

As illustrated in FIG. 8, to satisfy the above requirements for 8 bits quantization bit width, 10 bits quantization bit width, and 12 bits quantization bit width, an entire storage unit having a depth of 1536 and a width of 192 bits is needed for each line buffer. In some embodiments, the multiple storage array spaces of one line buffer can be formed by reconstituting a plurality of storage units of the one line buffer based on the quantization bit width. In some embodiments, the storage units can be reconstituted by, for example, address mapping, e.g., mapping between logical addresses and physical addresses of the ping-pong buffer. The reconstitution of a plurality of storage units can significantly reduce the total size required by a line buffer. In this disclosure, the depth and width of a storage unit is also referred to as a “storage depth” and a “storage width,” respectively.

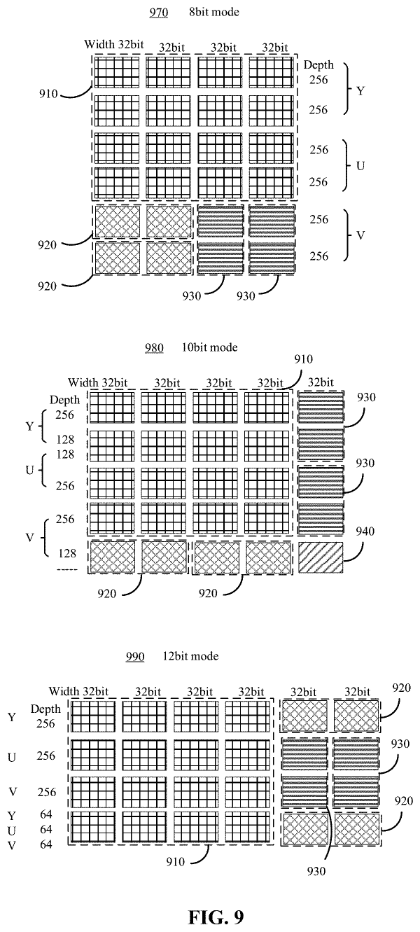

FIG. 9 shows schematic diagrams of exemplary reconstitution results of a line buffer for different quantization bit widths in accordance with some embodiments of the disclosure.

The line buffer can include a plurality of storage units. Each of the plurality of storage units can have a width that is an integral multiple of a common measure value determined at least based on the quantization bit width. In some embodiments, the common measure value can be a maximum common divisor of the minimum width requirements of the line buffer for all possible quantization bit widths. For example, for the 8 bits quantization bit width, 10 bits quantization bit width, and 12 bits quantization bit width, the common measure value can be the maximum common divisor, i.e., 32 bits, of the 128-bit, 160-bit, and 192-bit minimum width requirements.

Based on the common measure value, multiple storage units having different sizes can be determined. As illustrated in FIG. 9, the line buffer can include a first storage unit 910 having a width of 128 bits and a depth of 1024, two second storage units 920 each having a width of 64 bits and a depth of 256, two third storage units 930 each having a width of 32 bits and a depth of 512, and a fourth storage unit 940 having a width of 32 bits and a depth of 256. In some embodiments, each of the first storage unit 910, the second storage units 920, the third storage units 930, and the fourth storage unit 940 can include a continuous physical storage space in the second memory, e.g., the ping-pong buffer 260.

By reconstituting the first storage unit 910, the two second storage units 920, the two third storage units 930, and/or the fourth storage unit 940, three line buffers 970, 980, and 990 having different widths and depths can be formed for 8 bits quantization bit width, 10 bits quantization bit width, and 12 bits quantization bit width, respectively. The three line buffers 970, 980, and 990 can be realized by address mapping method based on different combination logic circuits. The corresponding software configuration can enable the hardware reconstruction of one or more of the three line buffers 970, 980, and 990. The “continuity” shown in FIG. 9 in both the width direction and the depth direction only means the data is logically continuously stored in the width direction and the depth direction of the line buffers, but does not necessarily mean the data is actually continuously stored in the corresponding physical storage spaces. In this disclosure, the width and depth of a line buffer, such as the line buffer 970, 980, or 990, are also referred to as a “logic width” and a “logic depth,” respectively, of the line buffer.

That is, by reconstituting multiple storages units of the line buffer in different combinations, the formed logic storage array spaces may have different logic widths and different logic depths. As such, the pixel data having one of the different quantization bit widths may be continuously stored in an array form in a corresponding one of the different logic storage array spaces.

It is noted that, the reconstitutions shown in FIG. 9 are only possible examples, any other suitable reconstitution can be performed to form the line buffers in the ping-pong buffer 260. That is, the number of the storage units, the size(s) of the storage units, and the reconstitution method may not be limited by the examples shown in FIG. 9. Any other suitable number of the storage units, any other suitable size(s) of the storage units, and any other suitable reconstitution methods can be used to reduce the sizes of the line buffers. For example, twenty five storage units each having a width of 32 bits and a depth of 256 can be used to achieve the similar reconstitution methods as shown in FIG. 9. As another example, one storage unit having a width of 192 bits and a depth of 1536 can be directly used as one line buffer without performing a reconstitution process.

It is also noted that the above processes of the flow diagram of FIG. 1 can be executed or performed in any order or sequence not limited to the order and sequence shown in the figures and described above. Also, some of the above processes of the flow diagrams of FIG. 1 can be executed or performed substantially simultaneously where appropriate or in parallel to reduce latency and processing time. Furthermore, FIG. 1 is provided as an example only. At least some of the processes shown in FIG. 1 may be performed in a different order than represented, performed concurrently, or altogether omitted.

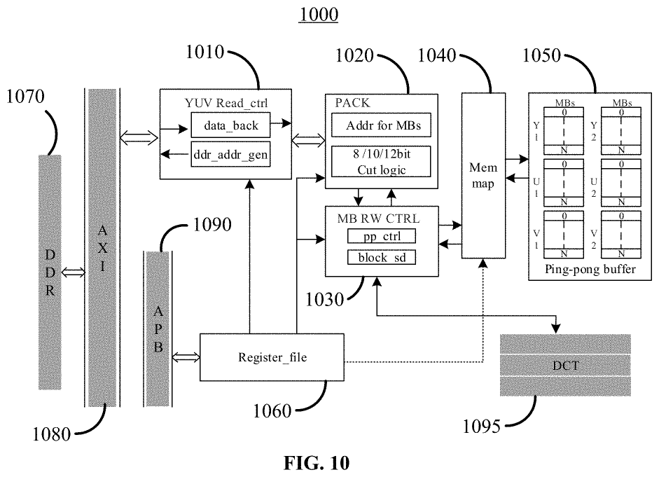

FIG. 10 shows a schematic hardware structural diagram of an exemplary apparatus 1000 for image processing in accordance with some embodiments of the disclosure. As illustrated, the apparatus 1000 for image processing includes a pixel data reading control circuit 1010, a pixel data segmentation circuit 1020, a pixel macro block reading and writing control circuit 1030, a memory cell mapping circuit 1040, a ping-pong buffer 1050, a file register 1060, a double data rate synchronous dynamic random-access memory (DDR) 1070, an advanced extensible interface (AXI) bus 1080, an advanced peripheral bus (APB) 1090, and a discrete cosine transform (DCT) circuit 1095.

The pixel data reading control circuit 1010 can include a DDR address generation logic circuit and a data read-back path which correspond to the YUV addressing module 240 shown in FIGS. 2 and 6A, and can be used for performing process 120 as discussed above in connection with FIG. 1. The pixel data segmentation circuit 1020 can include the data segmenting unit 752 and the storage addresses generating unit 754, the structure of which are shown in FIG. 7. The pixel data segmentation circuit 1020 can be used to perform process 130 as discussed above in connection with FIG. 1.

The pixel macro block reading and writing control circuit 1030 can include a ping-pong control logic circuit and an 8*8 pixel unit sending logic circuit, and can be used to perform processes 140 and 150 as discussed above in connection with FIG. 1. The memory cell mapping circuit 1040 can be used to reconstitute the ping-pong buffer 1050 based on the quantization bit width.

The file register 1060 can be read and written by software, and can be used to configure the image resolution, storage format, quantization bit width, DDR start addresses, and any other suitable parameters. The file register 1060 can generate the control signals for the pixel data reading control circuit 1010, the pixel data segmentation circuit 1020, the pixel macro block reading and writing control circuit 1030, the memory cell mapping circuit 1040, and the ping-pong buffer 1050.

The advanced peripheral bus (APB) 1090 can be used as an interface to any peripheral circuit that has low bandwidth and does not require high performance. For example, the advanced peripheral bus (APB) 1090 can be used to provide a port to configure registers including, but not limited to, image resolution register, image format register, stride configuration register, bit width of pixel register, etc.

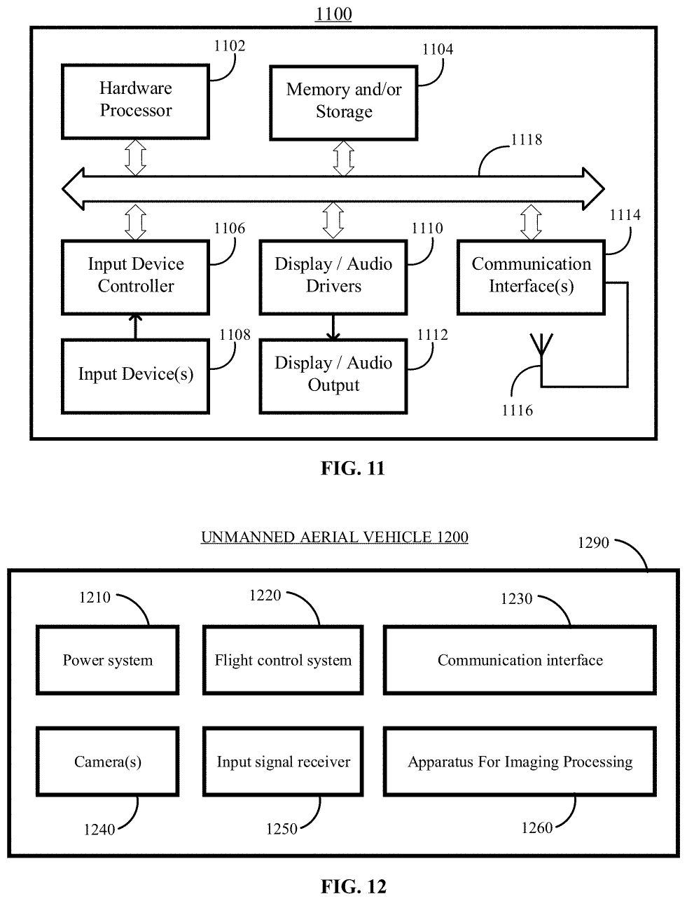

FIG. 11 shows a schematic structural diagram of an exemplary system 1100 for implementing an image processing method in accordance with some embodiments of the disclosure.

The system 1100 can be included in any suitable device configured to perform an image processing function, and/or perform any other suitable functions, such as communicating with one or more devices or severs though a communication network, receiving user request, processing and transmitting data, etc. For example, the system 1100 can be implemented in a mobile phone, a tablet computer, a laptop computer, a desktop computer, a set-top box, a television, a streaming media player, a game console, a server, or another suitable device.

As shown in FIG. 11, the system 1100 includes a hardware processor 1102, a memory and/or storage 1104, an input device controller 1106, an input device 1108, display/audio drivers 1110, a display and audio output circuitry 1112, communication interface(s) 1114, an antenna 1116, and a bus 1118.

The hardware processor 1102 can include any suitable hardware processors, such as a microprocessor, a micro-controller, a central processing unit (CPU), a graphics processing unit (GPU), an image signal processor (ISP), a discrete cosine transform (DCT) processor, a network processor (NP), a digital signal processor (DSP), an application specific integrated circuit (ASIC), a field-programmable gate array (FPGA), and/or other programmable logic device, discrete gate or transistor logic device, discrete hardware components. The hardware processor 1102 can implement or execute various embodiments of the disclosure including one or more methods, processes, and/or logic diagrams. For example, the hardware processor 1102 can implement or execute various embodiments of the disclosed method for image processing described above in connection with FIG. 1.

The memory and/or storage 1104 can be any suitable memory and/or storage for storing program codes, data, media content, image data, webpage URLs, channel page tables, raw data of webpage resources, information of users, and/or any other suitable content in some embodiments. For example, the memory and/or storage 1104 can include a random access memory (RAM), a double data rate synchronous dynamic random-access memory (DDR), a line buffer, a ping-pong buffer, a read only memory, a flash memory, a non-volatile memory, such as a hard disk storage, an optical media, and/or any other suitable storage device.

The input device controller 1106 can be any suitable circuitry for controlling and receiving input from one or more input devices 1108 in some embodiments. For example, the input device controller 1106 can be circuitry for receiving an input from a touch screen, from one or more buttons, from a voice recognition circuit, from a microphone, from a camera, from an optical sensor, from an accelerometer, from a temperature sensor, from a near field sensor, and/or any other suitable circuitry for receiving user input.

The display/audio drivers 1110 can be any suitable circuitry for controlling and driving output to one or more display and audio output circuitries 1112 in some embodiments. For example, the display/audio drivers 1110 can be circuitry for driving an LCD display, a speaker, an LED, and/or any other display/audio device.

The communication interface(s) 1114 can be any suitable circuitry for interfacing with one or more communication networks. For example, the interface(s) 1114 can include a network interface card circuitry, a wireless communication circuitry, and/or any other suitable circuitry for interfacing with one or more communication networks, such as the Internet, a wide area network, a local network, a metropolitan area networks, etc.

The antenna 1116 can be any suitable one or more antennas for wirelessly communicating with a communication network in some embodiments. In some embodiments, the antenna 1116 can be omitted when not needed.

In some embodiments, the communication network can be any suitable combination of one or more wired and/or wireless networks such as the Internet, an intranet, a wide-area network (WAN), a local-area network (LAN), a wireless network, a digital subscriber line (DSL) network, a frame relay network, an asynchronous transfer mode (ATM) network, a virtual private network (VPN), a WiFi network, a WiMax network, a satellite network, a mobile phone network, a mobile data network, a cable network, a telephone network, a fiber optic network, and/or any other suitable communication network, or any combination of any of such networks.

The bus 1118 can be any suitable mechanism for communicating between two or more components of the system 1100. The bus 1118 can include an address bus, a data bus, a control bus, etc. Specifically, the bus 1118 may include an advanced extensible interface (AXI) bus, an advanced peripheral bus (APB), and any other suitable buses as described above in connection with FIG. 10. The bus 1118 is represented as a two-way arrow in FIG. 11, but it does not mean that it is only one type bus or only one bus.

The processes in the disclosed method in various embodiments can be executed by a hardware decoding processor, or by a decoding processor including a hardware module and a software module. The software module may reside in any suitable storage/memory medium, such as a random access memory, a flash memory, a read-only memory, a programmable read-only memory, an electrically erasable programmable memory, a register, etc. The storage medium can be located in the memory and/or storage 1104. The hardware processor 1102 can implement the disclosed method by combining the hardware and the information read from the memory and/or storage 1104.

FIG. 12 shows a schematic structural diagram of another exemplary system for implementing an image processing method in accordance with some other embodiments of the disclosure. As illustrated, the system for implementing an image processing method can be an unmanned aerial vehicle 1200. The unmanned aerial vehicle 1200 includes an apparatus for image processing 1260. The apparatus 1260 can be, for example, the apparatus for image processing 1000 shown in FIG. 10. The unmanned aerial vehicle 1200 further includes an input signal receiver 1250, a power system 1210, a flight control system 1220, a communication interface 1230, one or more cameras 1240, and/or any other suitable components. Further, the unmanned aerial vehicle 1200 includes a housing 1290 for accommodating one or more of the above components.

In some embodiments, the unmanned aerial vehicle 1200 can be controlled by a remote control. The remote control can be a specific remote control device for the unmanned aerial vehicle 1200, or can be a software application implemented on a mobile smart device, such as a smartphone, a tablet computer, etc.

It is noted that, the flowcharts and block diagrams in the figures illustrate various embodiments of the disclosed method and apparatus, as well as architectures, functions and operations that can be implemented by a computer program product. In this case, each block of the flowcharts or block diagrams may represent a code segment or a portion of program code. Each code segment or portion of program code can include one or more executable instructions for implementing predetermined logical functions.

It is noted that, in some embodiments, the functions illustrated in the blocks can be executed or performed in any order or sequence not limited to the order and sequence shown in the figures and described above. For example, two consecutive blocks may actually be executed substantially simultaneously where appropriate or in parallel to reduce latency and processing times, or even be executed in a reverse order depending on the functionality involved in.

It is also noted that, each block in the block diagrams and/or flowcharts, as well as the combinations of the blocks in the block diagrams and/or flowcharts, can be realized by a dedicated hardware-based system for executing specific functions, or can be realized by a dedicated system combining hardware and computer instructions.

Accordingly, methods, systems, and media for image processing are provided. In the disclosed methods, systems, and media for image processing, the pixel data of multiple macro blocks of pixels can be read by a specific addressing method. Rather than reading the pixel data of an entire row of pixels of an image, the disclosed methods, systems, and media for image processing can eliminate the dependence of storage units on resolution.

Further, by using data segmentation, the valid pixel data can be extracted, allowing the disclosed methods, systems, and media for image processing to support any high resolution images that has a width and/or a height including a number of pixels that is a multiple of eight or sixteen. In addition, by reconstructing the storage units, the size of the ping-pong buffer can be further reduced, eliminating the dependency of the storage units on the quantization bit width.

As shown in the Table 1 below, taking the quantization bit width of 8 bits as an example, the minimum size requirements for a line buffer for four typical resolutions are listed for both of the existing method and the method consistent with the disclosure. In the existing method, the minimum size requirement for a line buffer is proportional to the width of the resolution. However, in the method consistent with the disclosure, the minimum size requirement for a line buffer can be less than that in the existing method, and can be fixed without being affected by the image resolution. Thus, for processing a high resolution image and/or video, such as a 4K image/video, a size requirement for the line buffer in the existing method is nearly ten times of the size requirement for the line buffer in the method consistent with the disclosure.

TABLE 1

| | Resolution | | | |
|---|---|---|---|---|
| | | 1920 × | 2560 × | 4096 × |
| | 1280 × 720 | 1080 | 1440 | 2160 |
| Existing method (bit) | 983040 | 1471560 | 1966080 | 3145728 |

| | |
|---|---|
| Disclosed method (bit) | 335872 |

The provision of the examples described herein (as well as clauses phrased as “such as,” “e.g.,” “including,” and the like) should not be interpreted as limiting the claimed subject matter to the specific examples; rather, the examples are intended to illustrate only some of many possible aspects.

Further, it is understood that the present disclosure has been made only by way of example, and that numerous changes in the details of embodiment of the disclosure can be made without departing from the spirit and scope of the disclosure. Features of the disclosed embodiments can be combined and rearranged in various ways. Without departing from the spirit and scope of the disclosure, modifications, equivalents, or improvements to the disclosure are understandable to those skilled in the art and are intended to be encompassed within the scope of the present disclosure. It should be noted that, similar reference numerals and letters are refer to similar items in the figures, and thus once an item is defined in one figure, there is no need to further define and/or explain the item in subsequent figures.

What is claimed is:

1. An image processing method, comprising:
reading a portion of pixel data of an array of pixels stored in a first memory, the array of pixels including a first number of successive rows of pixels and a second number of successive columns of pixels, the portion of the pixel data corresponding to a sub-array of the array of pixels including a third number of successive rows of pixels and a fourth number of successive columns of pixels, the third number being smaller than the first number, and the fourth number being determined based on a quantization bit width of the pixel data and being smaller than the second number;
storing the portion of the pixel data into a second memory; and
transmitting a sub-portion of the portion of the pixel data from the second memory to an image data processor, the sub-portion of the portion of the pixel data corresponding to at least one pixel matrix in the sub-array, each pixel matrix including the third number of successive rows of pixels.

2. The method of claim 1, further comprising:
storing, before reading the portion of the pixel data, the pixel data of the array of pixels into the first memory.

3. The method of claim 1,
wherein:
the portion of the pixel data is a first portion of the pixel data and the sub-array of the array of pixels is a first sub-array of the array of pixels, and
storing the first portion of the pixel data into the second memory includes storing the first portion of the pixel data into a first part of the second memory, the method further comprising:
reading a second portion of the pixel data stored in the first memory, the second portion of the pixel data corresponding to a second sub-array of the array of pixels, the second sub-array including the third number of successive rows of pixels and a fifth number of successive columns of pixels, and the fifth number being equal to or smaller than the fourth number;
storing the second portion of the pixel data into a second part of the second memory; and
transmitting a sub-portion of the second portion of the pixel data from the second part of the second memory to the image data processor, the sub-portion of the second portion of the pixel data corresponding to at least one pixel matrix in the second sub-array, each pixel matrix including the third number of successive rows of pixels.

4. The method of claim 3, wherein:
the first memory includes a double data rate synchronous dynamic random access memory;
the second memory and the second part of the second memory include line-buffers; and
the image data processor includes a discrete cosine transform processor.

5. The method of claim 1, wherein:
the first memory includes a double data rate synchronous dynamic random access memory;
the second memory includes a line-buffer; and
the image data processor includes a discrete cosine transform processor.

6. The method of claim 1, wherein:
the third number is 16; and
the fourth number is:
512 if the quantization bit width of the pixel data is 8 bits, or
384 if the quantization bit width is 10 bits, or
320 if the quantization bit width is 12 bits.

7. The method of claim 1, wherein storing the portion of the pixel data into the second memory includes:
reconstituting, based on the quantization bit width, a plurality of storage units of the second memory to form a plurality of logic storage array spaces for storing the portion of the pixel data.

8. The method of claim 7, wherein:
each of the plurality of storage units of the second memory has a width that is an integral multiple of a common measure value determined at least based on the quantization bit width.

9. The method of claim 8, wherein the second memory includes:
a first storage unit having a width of 128 bits and a depth of 1024;
two second storage units each having a width of 64 bits and a depth of 256; and
two third storage units each having a width of 32 bits and a depth of 512.

10. The method of claim 9, wherein the second memory further includes:
a fourth storage unit having a width of 32 bits and a depth of 256.

11. The method of claim 7, wherein:
different quantization bit width corresponds to different widths and/or depths of the plurality of logic storage array spaces.

12. The method of claim 7, wherein storing the portion of the pixel data into the second memory further includes:
storing first component information of the sub-array of the array of pixels into a first logic storage array space in an array form that follows relative positions of the pixels in the sub-array;
storing second component information of the sub-array of the array of pixels into a second logic storage array space in the array form; and
storing third component information of the sub-array of the array of pixels into a third logic storage array space in the array form.

13. The method of claim 12, wherein:
the first logic storage array space, the second logic storage array space, and the third logic storage array space have a same logic width.

14. A system for image processing, the system comprising:
a hardware processor; and
a memory storing instructions that, when executed by the hardware processor, cause the hardware processor to:
read a portion of pixel data of an array of pixels stored in a first memory, the array of pixels including a first number of successive rows of pixels and a second number of successive columns of pixels, the portion of the pixel data corresponding to a sub-array of the array of pixels including a third number of successive rows of pixels and a fourth number of successive columns of pixels, the third number being smaller than the first number, and the fourth number being determined based on a quantization bit width of the pixel data and being smaller than the second number;
store the portion of the pixel data into a second memory, and
transmit a sub-portion of the portion of the pixel data from the second memory to an image data processor, the sub-portion of the portion of the pixel data corresponding to at least one pixel matrix in the sub-array, each pixel matrix including the third number of successive rows of pixels.

15. The system of claim 14, wherein the instructions further cause the hardware processor to:
store, before reading the portion of the pixel data, the pixel data of the array of pixels into the first memory.

16. The system of claim 14, wherein:
the portion of the pixel data is a first portion of the pixel data and the sub-array of the array of pixels is a first sub-array of the array of pixels,
the first portion of the pixel data is stored into a first part of the second memory, and
the instructions further cause the hardware processor to:
read a second portion of the pixel data stored in the first memory, the second portion of the pixel data corresponding to a second sub-array of the array of pixels, the second sub-array including the third number of successive rows of pixels and a fifth number of successive columns of pixels, and the fifth number being equal to or smaller than the fourth number,
store the second portion of the pixel data into a second part of the second memory, and
transmit a sub-portion of the second portion of the pixel data from the second part of the second memory to the image data processor, the sub-portion of the second portion of the pixel data corresponding to at least one pixel matrix in the second sub-array, each pixel matrix including the third number of successive rows of pixels.

17. The system of claim 16, wherein:
the first memory includes a double data rate synchronous dynamic random access memory;
the second memory and the second part of the second memory include line-buffers; and
the image data processor includes a discrete cosine transform processor.

18. The system of claim 14, wherein:
the first memory includes a double data rate synchronous dynamic random access memory;
the second memory includes a line-buffer; and
the image data processor includes a discrete cosine transform processor.

19. The system of claim 14, wherein:
the third number is 16; and
the fourth number is:
512 if the quantization bit width of the pixel data is 8 bits, or
384 if the quantization bit width is 10 bits, or
320 if the quantization bit width is 12 bits.

20. The system of claim 14, wherein the instructions further cause the hardware processor to:
reconstitute, based on the quantization bit width, a plurality of storage units of the second memory to form a plurality of logic storage array spaces for storing the portion of the pixel data.
